(19) United States
(12) Patent Application Publication
(10) Pub. No.: US 2008/0307868 A1
(43) Pub. Date: Dec. 18, 2008

(54) AIR FLOW MEASURING DEVICE

(75) Inventor: Noboru KITAHARA, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/120,981

(22) Filed: May 15, 2008

(30) Foreign Application Priority Data
Jun. 14, 2007 (JP) 2007-157362

(51) Int. Cl. G01M 15/00

(52) U.S. Cl. 73/114.32

(57) ABSTRACT

An air flow measuring device includes a first sub-passage portion configured to introduce therein a part of air flowing in an interior of a duct, a passage-area reducing portion provided in the first sub-passage portion to gradually reduce a passage sectional area of the first sub-passage portion as toward an outlet of the first sub-passage portion, and a second sub-passage portion branched from the first sub-passage portion at an upstream side of the passage-area reducing portion in a flow direction of air flowing in the first sub-passage portion. The second sub-passage portion is configured to introduce therein a part of air flowing in the first sub-passage portion. Furthermore, a flow amount sensor is located at an inlet of the second sub-passage portion, at which the second sub-passage portion is branched from the first sub-passage portion, to measure a flow amount of air flowing in the second sub-passage portion.

### CROSS REFERENCE TO RELATED APPLICATION

This application is based on Japanese Patent Application No. 2007-157362 filed on Jun. 14, 2007, the contents of which are incorporated herein by reference in its entirety.

### BACKGROUND OF THE INVENTION

1. Field of the Invention

The present invention relates to an air flow measuring device having a flow amount sensor for measuring a flow amount of air.

2. Description of the Related Art

An air flow measuring device described in U.S. Pat. No. 7,089,788 (corresponding to JP 2005-140753A) is used as an air flow meter for measuring a flow amount of intake air flowing into an internal combustion engine. As shown in FIG. 4, the air flow measuring device includes a sensor body 110 disposed in an intake air passage 100 of the internal combustion engine. The sensor body 110 is provided with a first sub-passage 120 into which a part of air flowing in the intake air passage 100 is introduced, and a second sub-passage 130 into which a part of air flowing in the first sub-passage 120 is introduced A flow amount sensor 140 is located in the second sub-passage 130. The second sub-passage 130 is formed into approximately a U-shape around a partition wall 150, and the flow amount sensor 140 is located at a U-turning portion (bent portion) of the second sub-passage 130, as shown in FIG. 4.

In the flow amount measuring device, when dust becomes in a state without having inertia force due to affect of pulsation of intake air, dust may stay at an inlet of the second sub-passage 130. In this case, if the dust staying at the inlet of the second sub-passage 130 flows into the U-turning portion of the second sub-passage 130 at the next air intake time, the dust may collides with the flow amount sensor 140. Because the dust flowing into the second sub-passage 130 can be sufficiently accelerated by the air flow generated in the second sub-passage 130, the flow amount sensor 140 may be damaged when the accelerated dust collides with the flow amount sensor 140. In particular, when a thin film-like measuring element is used in the flow amount sensor 140, the measuring element is easily damaged by the collision of the dust.

Furthermore, as shown in FIG. 5, a flow direction of the air introduced from the first sub-passage 120 into the second sub-passage 130 is bent approximately perpendicular at the inlet of the second sub-passage 130. Therefore, the flow of air contracted at the inlet of the second sub-passage 130 by the bending is gradually enlarged in the second sub-passage 130 and reaches the flow amount sensor 140. As a result, the air flow is disturbed in the second sub-passage 130, and thereby a variation in the output of the flow amount sensor 140 may be caused.

### SUMMARY OF THE INVENTION

In view of the foregoing problems, it is an object of the present invention to provide an air flow measuring device, which can effectively reduce a damage to a flow amount sensor due to a collision of dust.

It is another object of the present invention to provide an air flow measuring device, which can effectively reduce a damage to a flow amount sensor due to a collision of dust while reducing a variation in output of the flow amount sensor.

According to an aspect of the present invention, an air flow measuring device includes a first sub-passage portion configured to introduce therein a part of air flowing in an interior of a duct, a passage-area reducing portion provided in the first sub-passage portion to gradually reduce a passage sectional area of the first sub-passage portion as toward an outlet of the first sub-passage portion, and a second sub-passage portion branched from the first sub-passage portion at an upstream side of the passage-area reducing portion in a flow direction of air flowing in the first sub-passage portion. The second sub-passage portion is configured to introduce therein a part of air flowing in the first sub-passage portion. In the air flow measuring device, a flow amount sensor is located at an inlet of the second sub-passage portion, at which the second sub-passage portion is branched from the first sub-passage portion, to measure a flow amount of air flowing in the second sub-passage portion.

Because the flow amount sensor is located at the inlet of the second sub-passage portion, even when dust staying at the inlet of the second sub-passage flows into the second sub-passage portion, the dust without being sufficiently accelerated collides with the flow amount sensor. That is, the flow speed of the dust when being collided with the flow amount sensor becomes low, thereby reducing a damage of the flow amount sensor due to the collision of the dust. Furthermore, air introduced from the first sub-passage portion to the second sub-passage portion reaches the flow amount sensor in a state where the air flow is contracted by bending at the inlet of the second sub-passage portion. That is, air introduced from the first sub-passage portion to the second sub-passage portion reaches the flow amount sensor before a disturbance of the air flow is generated. Therefore, the flow speed of air flowing to the flow amount sensor can be made stable, and a variation in the output of the flow amount sensor can be reduced.

For example, the inlet of the second sub-passage portion branched from the first sub-passage portion has an upstream end point (A), and a downstream end point (B) positioned downstream from the upstream end point (A) in the flow direction of air flowing in the first sub-passage portion. In this case, the downstream end point (B) is positioned away from a base line corresponding to an axial line of the first sub-passage portion, more than the upstream end point (A), and a portion of the flow amount sensor is located between the upstream end point (A) and the downstream end point (B) to be held by the upstream end point (A) and the downstream end point (B).

As an example, the flow amount sensor may include a semiconductor substrate having thereon a film resistor, and a support member for supporting the semiconductor substrate. In this case, a portion of the support member can be located between the upstream end point (A) and the downstream end point (B), and can be held by the upstream end point (A) and the downstream end point (B).

The first sub-passage portion may have therein a wall portion for defining the passage-area reducing portion at a downstream side of the inlet of the second sub-passage portion in the flow direction of air in the first sub-passage portion. In this case, the wall portion may have a tilt surface that is tilted to gradually reduce a passage sectional area as toward the outlet of the first sub-passage portion and to form a throttle portion at the outlet of the first sub-passage portion or at a position close to the outlet of the first sub-passage portion. Alternatively, the wall portion may have a tilt surface that is tilted to gradually reduce a passage radial dimension as toward the outlet of the first sub-passage portion in cross section perpendicular to the flow direction of air flowing into the inlet of the second sub-passage portion. In this case, a pressure difference between the inlet side and the outlet side of the first sub-passage can be increased.

The second sub-passage portion may be provided to have a U-shape air passage. In this case, the inlet of the second sub-passage portion may be branched from the first sub-passage portion such that a flow direction of air flowing into the inlet of the second sub-passage portion is approximately perpendicular to the flow direction of air flowing in the first sub-passage portion.

The flow amount measuring device may be used for an internal combustion engine, for example. In this case, the duct is configured to define therein an intake air passage communicating with an intake air port of the internal combustion engine, such that the air flowing in the duct flows into the internal combustion engine.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a cross sectional view showing an air flow measuring device according to a first embodiment of the present invention;

FIG. 2 is a cross sectional view for explaining a structure of a sensor body according to the first embodiment;

FIG. 3A is a cross sectional view showing an air flow measuring device according to a second embodiment of the present invention, and FIG. 3B is a cross sectional view taken along the line IIIB-IIIB in FIG. 3A;

FIG. 4 is a cross sectional view showing an air flow measuring device in a prior art; and

FIG. 5 is a cross sectional view showing an air flow measuring device in the prior art.

### DETAILED DESCRIPTION OF THE PREFERRED EMBODIMENTS

### First Embodiment

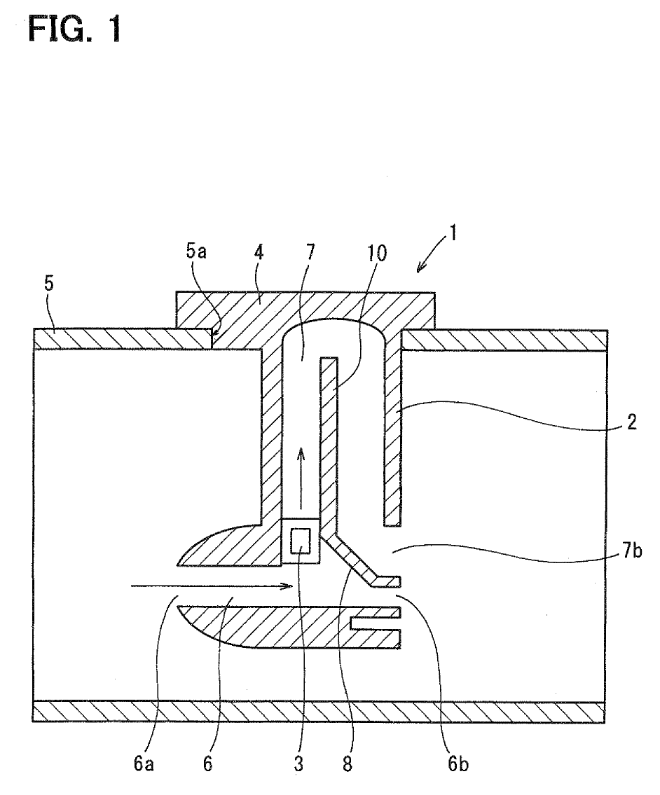

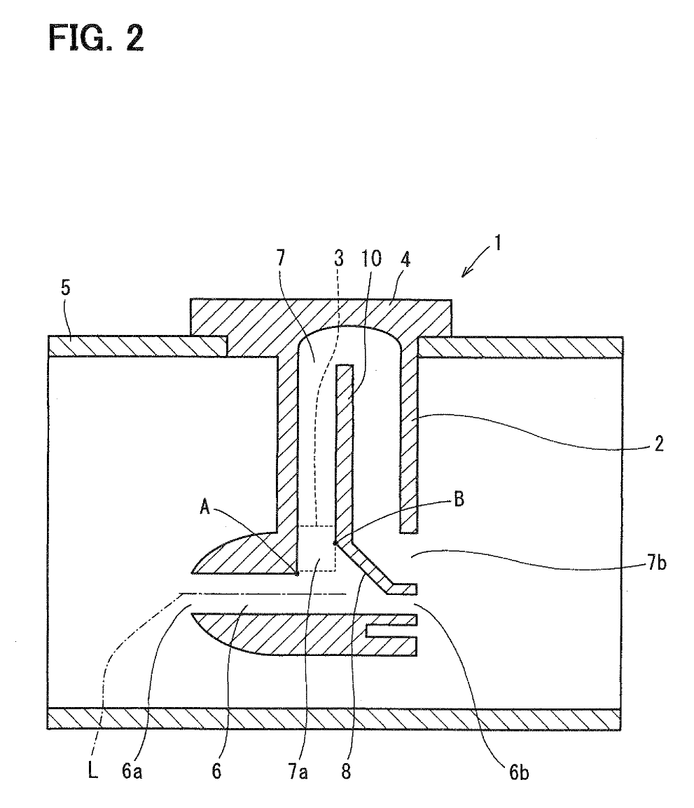

An air flow measuring device 1 of a first embodiment will be now described with referent to FIGS. 1 and 2. For example, the air flow measuring device 1 can be used as an air flow meter for measuring a flow amount of intake air in an internal combustion engine for a vehicle. The air flow measuring device 1 includes a sensor body 2, a flow amount sensor 3 and a circular module 4.

The sensor body 2 is inserted into an interior of an intake air duct 5 of the engine. Air flows into an intake air port of the engine through the intake air duct 5. The intake air duct 5 has an attachment hole portion 5a into which the sensor body 2 is fitted after the sensor body 2 inserted into the interior of the intake air duct 5. The sensor body 2 is provided with a first sub-passage 6 into which a part of air flowing in the intake air duct 5 is introduced, and a second sub-passage 7 into which a part of air flowing in the first sub-passage 6 is introduced.

In the example of FIG. 1, air flows through the intake air duct 5 from the left side toward the right side. The first sub-passage 6 has an inlet 6a that is open toward an upstream air side (i.e., left side in FIG. 1) of the intake air duct 5, and an outlet 6b that is open toward a downstream air side (i.e., right side in FIG. 1) of the intake air duct 5. The first sub-passage 6 is formed to extend approximately in a straight line from the inlet 6a to the outlet 6b along the flow direction of air in the intake air duct 5. Furthermore, a wall portion having a tilt surface 8 is provided in the first sub-passage 6 so as to receive a dynamic pressure of air flowing in the first sub-passage 6.

The second sub-passage 7 has an inlet 7a branched from the first sub-passage 6, and an outlet 7b opened toward the downstream air side of the intake air duct 5 at a position adjacent to the outlet 6b of the first sub-passage 6. A partition wall 10 is located in the sensor body 2 so that the second sub-passage 7 is formed to be U-turned from the inlet 7a to the outlet 7b. In this embodiment, the flow direction of air flowing into the inlet 7a is turned substantially by 180° in the second sub-passage 7 at one end side opposite to the inlet 7a and the outlet 7b. The partition wall 10 is spaced from the inner wall of the second body 2 to form a turning portion at the one end side opposite to the inlet 7a and the outlet 7b. The partition wall 10 extends in a direction approximately perpendicular to the flow direction of air in the first sub-passage 6. The tilt surface 8 is located to be tilted from the extending direction of the partition wall I O The tilt surface 8 is tilted from the lower end of the partition wall 10 toward the downstream side of the flow direction of air flowing through the first sub-passage 6, such that the flow direction of air in the first sub-passage is partially crossed with the tilt surface 8. The tilt surface 8 extends toward a base line L shown in FIG. 2, and the outlet 6b of the first sub-passage 6 is provided at a downstream side of the tilt surface 8. Here, the base line L shown in FIG. 2 is an axial line passing the center of the first sub-passage 6.

The inlet 7a of the second sub-passage 7 has an upstream end point A that is a corner point bent approximately by a right angle from the first sub-passage 6 into the inlet 7a of the second passage 7, and a downstream end point B positioned downstream from the upstream end point A in the flow direction of air in the first sub-passage 6. The downstream end point B is separated from the base line L by a distance that is larger than a distance between the upstream end point A and the base line L, in a direction perpendicular to the base line L. Therefore, the open surface of the inlet 7a of the second sub-passage 7, opened between the upstream end point A and the downstream end point 8, is tilted to face toward the outlet 6b of the first sub-passage 6.

The tilt surface 8 is tilted and extends into the first sub-passage 6 such that the passage sectional area of the first sub-passage 6 is gradually reduced as toward the outlet 6b of the first sub-passage 6 That is, a passage-area reducing portion is formed in the first sub-passage 6 at a downstream side of the branch portion (i.e., inlet 7a) in the flow direction of air in the first sub-passage 6. As shown in FIGS. 1 and 2, the passage sectional area of the first sub-passage 6 becomes smallest at the outlet 6b to be throttled at the outlet 6b. Therefore, a throttle portion is formed in the first sub-passage 6 at a downstream side of the tilt surface 8 in the flow direction of air in the first sub-passage 6.

The flow amount sensor 3 measures and detects a flow amount of air flowing through the second sub-passage 7, and output the detected flow amount as an electrical signal (e.g., electrical voltage signal). For example, the flow amount sensor 3 includes a temperature sensing element and a heat generating element formed on a surface of a semiconductor substrate by a thin film resistor (not show) The heat generating element and the temperature sensing element are connected to a circuit substrate (not shown) located inside the circuit module 4.

The flow amount sensor 3 is located at the inlet 7a of the second sub-passage 7 to be held at least by the point A and the point B. As shown in FIGS. 1 and 2, the flow amount sensor 3 is positioned outside of the point A with respect to the base line L of the first sub-passage 6, and a portion of the flow amount sensor 3 (e.g., semiconductor substrate) is positioned in the inlet 7a of the second sub-passage 7 between the point A and the point B. In the example shown in FIG. 2, the flow amount sensor 3 is positioned above the point A, and the point B is positioned at a portion of the flow amount sensor 3 between the top end and the bottom end of the flow amount sensor 3.

The circuit module 4 is formed integrally with the sensor body 2, and is located outside of the intake air duct 5. The circuit module 4 controls an electrical current value applied to the heat generating element so that a difference between the temperature of the heat generating element and air temperature detected by the temperature sensing element becomes constant.

Next, operation of the air flow measuring device 1 will be described.

When air flows in the intake air duct 5 when operation of the engine is started, a part of air in the intake air duct 5 is introduced into the first sub-passage 6 of the sensor body 2, and a part of air flowing in the first sub-passage 6 is introduced into the second sub-passage 7 The flow amount sensor 3 located at the inlet 7a of the second sub-passage 7 is set such that the heat radiating amount of the heat generating element of the flow amount sensor 3 becomes larger as the flow speed of air flowing in the second sub-passage 7 becomes larger. Therefore, in the flow amount sensor 3, the electrical current value applied to the heat generating element is made larger as the flow speed of air in the second sub-passage 7 becomes larger so that the temperature difference between the temperature of the heat generating element and the air temperature detected by the temperature sensing element becomes constant. In contrast, when the flow amount of air flowing in the second sub-passage 7 becomes smaller, the heat radiating amount of the heat generating element is decreased, thereby the electrical current value applied to the heat generating element becomes smaller. An electrical signal (e.g., electrical current signal) corresponding to the electrical current value applied to the heat generating element is output from the circuit module 4 to an exterior ECU (i.e., electronic control unit) so that the flow amount of the intake air is measured by the ECU.

In the air flow measuring device I of the first embodiment, the open surface of the inlet 7a of the second sub-passage 7 is tilted from a surface parallel to the flow direction of air in the first sub-passage 6, toward the direction of the outlet 6b. That is, as shown in FIG. 2, the point B of the inlet 7a is positioned away than the point A of the inlet 7a, with respect to the base line L. Therefore, dust flowing together with air in the first sub-passage 6 is difficult to flow into the second sub-passage 7 because the dust has a larger inertial force (i.e., high flow speed).

The flow amount sensor 3 is located at the inlet 7a of the second sub-passage 7. Thus, even when dust staying at the inlet 7a of the second sub-passage 7 flows into the second sub-passage 7 while a part of air flowing in the first sub-passage 6 is introduced into the second sub-passage 7, the dust without being sufficiently accelerated collides with the flow amount sensor 3. That is, the flow speed of the dust when being collided with the flow amount sensor 3 becomes low, thereby reducing a damage of the flow amount sensor 3 due to the collision with the dust.

Furthermore, air introduced from the first sub-passage 6 to the second sub-passage 7 reaches the flow amount sensor 3 in a state where the air flow is contracted at the inlet 7a of the second sub-passage 7. That is, air introduced from the first sub-passage 6 to the second sub-passage 7 reaches the flow amount sensor 3 before a disturbance of the air flow is generated. Therefore, the flow speed of air to the flow amount sensor 3 can be made stable, and a variation in the output of the flow amount sensor 3 can be reduced.

Furthermore, the tilt surface 8 is provided at the downstream side of the branched portion (i.e., inlet 7a) of the second sub-passage 7 so as to reduce the passage sectional area of the first sub-passage 6 at a position close to the outlet 6b. That is, a throttle portion having a reduced passage sectional area is formed at a downstream side in the first sub-passage 6 by using the tilt surface 8. Accordingly, the dynamic pressure of air flowing in the first sub-passage 6 is applied to the tilt surface 8, thereby increasing the pressure difference between the inlet side and the outlet side of the first sub-passage 6. As a result, an air amount that is sufficient for the measuring at the flow amount sensor 3 can flow into the second sub-passage 7, and the detection accuracy of the flow amount sensor 3 can be made stable.

According to the first embodiment of the present invention, the air flow measuring device 1 includes the first sub-passage 6 that is configured to introduce therein a part of air flowing in the interior of the intake air duct 5, a passage-area reducing portion provided in the first sub-passage 6 to gradually reduce a passage sectional area of the first sub-passage 6 as toward the outlet 6b of the first sub-passage 6, the second sub-passage 7 branched from the first sub-passage 6 at an upstream side of the passage-area reducing portion in the flow direction of air flowing in the first sub-passage 6, and the flow amount sensor 3 that is located at the inlet 7a of the second sub-passage 7, at which the second sub-passage 7 is branched from the first sub-passage 6, to measure a flow amount of air flowing in the second sub-passage 7. In the first embodiment, the other structure can be suitably changed in the air flow measuring device 1.

### Second Embodiment

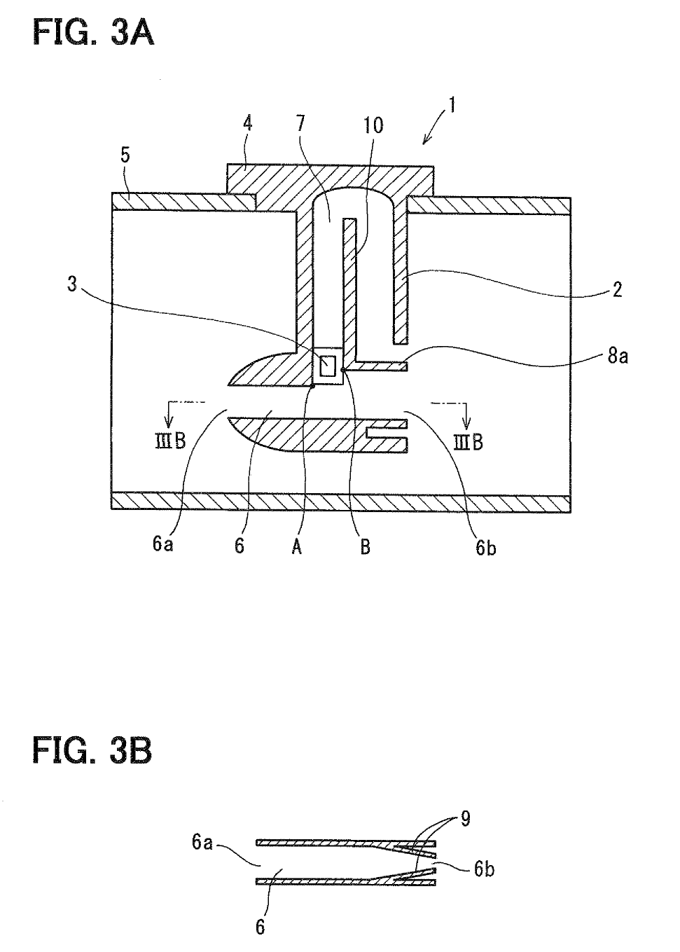

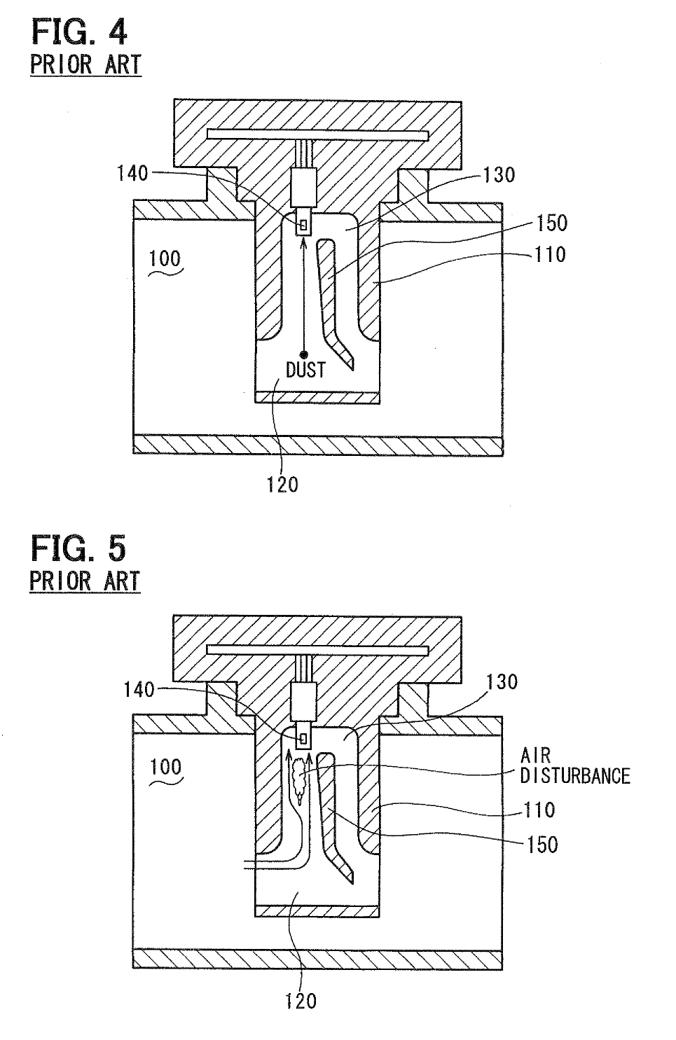

A second embodiment of the present invention will be described with reference to FIGS. 3A and 3B. In the second embodiment, the structure of the first sub-passage 6, for forming the throttle portion at a downstream side position in the first sub-passage 6, is made different from that of the above-described first embodiment.

In the second embodiment, a first radial direction of the first sub-passage 6 indicates the top-bottom direction of FIG. 3A, and a second radial direction of the first sub-passage 6 indicates a radial direction perpendicular to the top-bottom direction shown in FIG. 3A. FIG. 3B is a cross-sectional view taken along the line IIIB-IIIB of FIG. 3A, and shows the radial dimension of the first sub-passage 6 in the second radial direction.

As shown in FIG. 3B, a pair of wall portions 9 are provided in the first sub-passage 6 to gradually reduce a passage sectional dimension in the second radial direction as toward the outlet 6b. The wall portions 9 are provided to extend in a direction parallel to the first radial direction (i.e., top-bottom direction of FIG. 3A). As shown in FIG. 3B, the wall portions 9 are tilted with respect to the axial line of the first sub-passage 6, such that the clearance between the wall portions 9 is gradually reduced as toward downstream and the outlet 6b is formed at the downstream end side of the pair of the wall portions 9.

The inlet 7a of the second sub-passage 7 has an upstream end point A that is a corner point bent approximately by a right angle from the first sub-passage 6 to the inlet 7a of the second passage 7, and a downstream end point B positioned downstream from the upstream end point A in the flow direction of air in the first sub-passage 6. The downstream end point B is separated from the base line of the first sub-passage 6 by a distance that is larger than a distance between the upstream end point A and the base line, in a direction (top-bottom direction of FIG. 3A) perpendicular to the base line of the first sub-passage 6. Therefore, the open surface of the inlet 7a of the second sub-passage 7, opened between the upstream end point A and the downstream end point B, is tilted to face toward the outlet 6b of the first sub-passage 6, similarly to the above-described first embodiment. However, in the second embodiment, the tilt surface 8 of the first embodiment is not provided In the second embodiment, a wall surface 8a is provided to have substantially the same height position from the point B to the outlet 6b of the first sub-passage 6 as shown in FIG. 3A.

The flow amount sensor 3 is located at the inlet 7a of the second sub-passage 7 to be held in the inlet 7a opened between the point A and the point B.

According to the second embodiment, the open surface of the inlet 7a of the second sub-passage 7 is tilted toward the direction of the outlet 6b. That is, as shown in FIG. 3A, the point B of the inlet 7a is positioned away more than the point A of the inlet 7a, with respect to the base line L. Therefore, dust flowing together with air in the first sub-passage 6 is difficult to flow into the second sub-passage 7 because the dust has a larger inertial force (i.e., high flow speed).

The flow amount sensor 3 is located at the inlet 7a of the second sub-passage 7. Thus, even when dust staying at the inlet 7a of the second sub-passage 7 flows into the second sub-passage 7 while a part of air flowing in the first sub-passage 6 is introduced into the second sub-passage 7, the dust without being sufficiently accelerated collides with the flow amount sensor 3. Accordingly, the flow speed of the dust when being collided with the flow amount sensor 3 becomes low, thereby reducing a damage of the flow amount sensor 3 due to the collision with the dust.

Furthermore, air introduced from the first sub-passage 6 to the second sub-passage 7 reaches the flow amount sensor 3 in a state where the air flow is contracted at the inlet 7a of the second sub-passage 7. That is, air introduced from the first sub-passage 6 to the second sub-passage 7 reaches the flow amount sensor 3 before a disturbance of the air flow is generated. Therefore, the flow speed of air to the flow amount sensor 3 can be made stable, and a variation in the output of the flow amount sensor 3 can be reduced.

Furthermore, the wall portions 9 are provided in the first sub-passage 6 at the downstream side of the branch portion (i.e., inlet 7a) in the flow direction of air in the first sub-passage 6, so as to reduce the passage sectional area of the first sub-passage 6 at a position close to the outlet 6b. That is, a throttle portion having a reduced passage sectional area is formed at a downstream side in the first sub-passage 6 by using the wall portions 9. Accordingly, the dynamic pressure of air flowing in the first sub-passage 6 is applied to the wall portions 9, thereby increasing the pressure difference between the inlet side and the outlet side of the first sub-passage 6. As a result, an air amount that is sufficient for the measuring at the flow amount sensor 3 can flow into the second sub-passage 7, and the detection accuracy of the flow amount sensor 3 can be made stable.

### Other Embodiments

Although the present invention has been fully described in connection with the preferred embodiments thereof with reference to the accompanying drawings, it is to be noted that various changes and modifications will become apparent to those skilled in the art.

For example, in the above-described first embodiment, the flow amount sensor 3 is located at the inlet 7a of the second sub-passage 7 such that a portion of the flow amount sensor 3 (e.g., a portion of the semiconductor substrate) is held by the inlet 7a of the second sub-passage 7. However, the flow amount sensor 3 may be located at the inlet 7a of the second sub-passage 7 such that a portion of a support member for supporting the semiconductor substrate of the flow amount sensor 3 is held by the inlet 7a of the second sub-passage 7.

In the above-described first embodiment, the tilt surface 8 is provided so as to form a passage-area reducing portion in the first sub-passage 6, in which the passage sectional area is gradually reduced toward the outlet 6b of the first sub-passage 6. Furthermore, in the above-described second embodiment, the pair of the wall portions 9 is provided so as to form a passage-area reducing portion in the first sub-passage 6, in which the passage sectional area is gradually reduced toward the outlet 6b of the first sub-passage 6. However, the passage-area reducing portion can be formed in the first sub-passage 6 with a structure other than the tilt surface 8 or the wall portion 9.

Such changes and modifications are to be understood as being within the scope of the present invention as defined by the appended claims.

What is claimed is:

1. An air flow measuring device comprising:
a first sub-passage portion configured to introduce therein a part of air flowing in an interior of a duct;
a passage-area reducing portion provided in the first sub-passage portion to gradually reduce a passage sectional area of the first sub-passage portion as toward an outlet of the first sub-passage portion;
a second sub-passage portion branched from the first sub-passage portion at an upstream side of the passage-area reducing portion in a flow direction of air flowing in the first sub-passage portion, the second sub-passage portion being configured to introduce therein a part of air flowing in the first sub-passage portion; and
a flow amount sensor that is located at an inlet of the second sub-passage portion, at which the second sub-passage portion is branched from the first sub-passage portion, to measure a flow amount of air flowing in the second sub-passage portion.

2. The air flow measuring device according to claim 1, wherein:
the inlet of the second sub-passage portion branched from the first sub-passage portion has an upstream end point (A), and a downstream end point (B) positioned downstream from the upstream end point (A) in the flow direction of air flowing in the first sub-passage portion;
the downstream end point (B) is positioned away from a base line corresponding to an axial line of the first sub-passage portion, more than the upstream end point (A); and
a portion of the flow amount sensor is located between the upstream end point (A) and the downstream end point (B), and is held by the upstream end point (A) and the downstream end point (B).

3. The air flow measuring device according to claim 2, wherein:
the flow amount sensor includes a semiconductor substrate having thereon a film resistor, and a support member for supporting the semiconductor substrate; and
a portion of the support member is located between the upstream end point (A) and the downstream end point (B), and is held by the upstream end point (A) and the downstream end point (B).

4. The air flow measuring device according to claim 2, wherein:
the first sub-passage portion has therein a wall portion for defining the passage-area reducing portion at a downstream side of the inlet of the second sub-passage portion in the flow direction of air in the first sub-passage portion; and
the wall portion has a tilt surface that is tilted to gradually reduce a passage sectional area as toward the outlet of the first sub-passage portion and to form a throttle portion at the outlet of the first sub-passage portion.

5. The air flow measuring device according to claim 2, wherein:
the second sub-passage portion is provided to have a U-shape air passage; and
the inlet of the second sub-passage portion is branched from the first sub-passage portion such that a flow direction of air flowing into the inlet of the second sub-passage portion is approximately perpendicular to the flow direction of air flowing in the first sub-passage portion.

6. The air flow measuring device according to claim 2, wherein:
the first sub-passage portion has therein a wall portion for defining the passage-area reducing portion at a downstream side of the inlet of the second sub-passage portion in the flow direction of air in the first sub-passage portion; and
the wall portion has a tilt surface that is tilted to gradually reduce a passage radial dimension as toward the outlet of the first sub-passage portion in cross section perpendicular to the flow direction of air flowing into the inlet of the second sub-passage portion.

7. The air flow measuring device according to claim 2, wherein:
the passage-area reducing portion is configured to gradually reduce the passage sectional area of the first sub-passage portion from the downstream end point (B) to a position close to the outlet of the first sub-passage portion in the flow direction of air flowing in the first sub-passage portion.

8. The air flow measuring device according to claim 1 wherein:
the duct is configured to define therein an intake air passage communicating with an intake air port of an internal combustion engine, such that the air flowing in the duct flows into the internal combustion engine.
